(19) United States
(12) Patent Application Publication
(10) Pub. No.: US 2026/0038857 A1
(43) Pub. Date: Feb. 5, 2026

(54) SYSTEMS AND METHODS FOR MULTI-INPUT ANODE LOOP CONTROL FOR FUEL CELLS

(71) Applicant: Caterpillar Inc., Peoria, IL (US)

(72) Inventors: Shivangi Wagle, Peoria, IL (US); David Andrew Pierpont, Dunlap, IL (US); Chinmay Shah, Peoria, IL (US); Liam Pepe Wenzel, Peoria Heights, IL (US); Sachin S. Deshmukh, Dunlap, IL (US)

(73) Assignee: Caterpillar Inc., Peoria, IL (US)

(21) Appl. No.: 18/790,150

(22) Filed: Jul. 31, 2024

(51) Int. Cl. H01M 8/04746; H01M 8/04089; H01M 8/0432; H01M 8/0438; H01M 8/04537; H01M 8/04664

(52) U.S. Cl. CPC H01M 8/04753; H01M 8/04097; H01M 8/0432; H01M 8/04388; H01M 8/04582; H01M 8/04611; H01M 8/04671

(57) ABSTRACT

A fuel cell system may include a valve, a hydrogen source, an anode loop, a blower, a pressure sensor, and an anode controller. The valve is communicably coupled to a hydrogen source and configured to supply hydrogen to an anode loop. The blower is arranged to supply recycled hydrogen to the anode loop. The pressure sensor is configured to sense an anode inlet pressure. The anode controller is configured to determine a target anode inlet pressure, according to a current demand. The anode controller is configured to execute a feedback control loop, using the anode inlet pressure, to control the blower and the valve, to supply hydrogen to the anode loop.

### TECHNICAL FIELD

The present implementations relate generally to the field of fuel cells, and more particularly to systems and methods for a multi-input anode loop control for fuel cells.

### BACKGROUND

Fuel cells may be used to generate/supply electrical power in various use cases and applications. In some implementations, fuel cells may be provided as an energy source for various machinery. Such fuel cells may include proton exchange membrane (PEM) fuel cells. In a PEM fuel cell, hydrogen may be supplied to an anode loop, and oxygen may be supplied to the cathode loop. Such fuel systems may include a control system or solution which regulate the amount of hydrogen supplied to the anode loop, to prevent over/under saturation.

For example, U.S. Patent Application Publication No. 2023/0118048 describes a hydrogen fuel cell anode control system including a hydrogen inlet that receives pressurized hydrogen, a hydrogen outlet fluidically coupled to an anode manifold of a hydrogen fuel cell, a recirculation inlet that receives overflow hydrogen from the anode manifold, and a hydrogen pressure regulator configured to receive pressurized hydrogen from the hydrogen inlet. A hydrogen recirculation module mixes hydrogen received from the hydrogen pressure regulator and the recirculation inlet, and provides a hydrogen mixture to the hydrogen outlet. A differential pressure measurement module measures a differential pressure between the anode manifold and a cathode manifold of the hydrogen fuel cell. A controller controls at least one of the hydrogen pressure regulator or the hydrogen recirculation module based on the measured differential pressure.

### SUMMARY

A first aspect provided herein relate to a fuel cell system including a valve, a hydrogen source, an anode loop, a blower, a pressure sensor, and an anode controller. The valve is communicably coupled to a hydrogen source and configured to supply hydrogen to an anode loop. The blower is arranged to supply recycled hydrogen to the anode loop. The pressure sensor is configured to sense an anode inlet pressure. The anode controller is configured to determine a target anode inlet pressure, according to a current demand. The anode controller is configured to execute a feedback control loop, using the anode inlet pressure, to control the blower and the valve, to supply hydrogen to the anode loop.

A second aspect provided herein relate to a method of multi input anode loop control for fuel cells. The method includes receiving, by an anode controller, an anode inlet pressure of an anode loop of a fuel cell. The method includes determining, by an anode controller, a target anode inlet pressure, according to a current demand. The method includes executing, by the anode controller, using the anode inlet pressure, a feedback loop to control 1) a valve a valve fluidically coupled to a hydrogen source and configured to supply hydrogen to the anode loop, and 2) a blower arranged to supply recycled hydrogen to the anode loop, to supply hydrogen to the anode loop.

A third aspect provided herein relate to an anode controller of a fuel cell. The anode controller includes one or more processors. The one or more processors are configured to determine a target anode inlet pressure for an anode loop of a fuel cell system, according to a current demand. In some embodiments, the one or more processors are configured to receive, from an anode inlet pressure sensor, an anode inlet pressure. In some embodiments, the one or more processors are configured to execute a feedback control loop, using the anode inlet pressure, to control a blower arranged to supply recycled hydrogen to the anode loop and a valve communicably coupled to a hydrogen source and configured to supply hydrogen to the anode loop, to supply hydrogen to the anode loop. In some embodiments, the anode controller executes the feedback control loop, by executing a proportional and integral (PI) controller which receives the anode inlet pressure of the pressure sensor as an error signal.

### BRIEF DESCRIPTION OF THE DRAWINGS

FIG. 1 is a block diagram of a fuel cell system for multi-input anode loop control for fuel cells, in accordance with present implementations.

FIG. 2 is a block diagram of the fuel cell system, in accordance with present implementations.

FIGS. 3A-3C are a flowchart of the multi-input anode loop, in accordance with present implementations.

FIG. 4 is a flowchart showing a method for the multi-input anode loop control for fuel cells, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems and methods described herein may be configured, designed, or otherwise arranged to implement multi-input loop control for fuel cells to providing an adequate amount of Hydrogen to the fuel cell. Fuel cells typically vary in demands for hydrogen based on the type of fuel cell, efficiency of the cell, and the electrical power output needed. To calculate the demand, the fuels cells operate based on a stoichiometric ratio to indicate a specific amount of hydrogen from an anode that needs to interact with oxygen (or air) at the cathode in the fuel cell. In a Proton Exchange Membrane (PEM), the reaction between hydrogen and oxygen is represented as

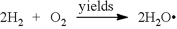

Various components of the fuel cell (e.g., pressure control valve (PCV), hydrogen recirculation blower (HRB), ejector) can obtain the net hydrogen that a stack requires at the anode. However, inefficient use of the components results in wasted hydrogen and decreased efficiency of the fuel cell. Furthermore, the inefficient use of the components results in a higher carbon footprint by not reutilizing excess hydrogen. According to the systems and methods described herein, an anode controller can use physics based hydrogen calculations to set a desired hydrogen pressure and calculate anode stoichiometry in real time. Furthermore, according to the systems and methods described herein optimize flow in the stack in parallel by using an anode loop to trim the fresh hydrogen supply based on error between the hydrogen pressure and the mean pressure of the stacks in parallel.

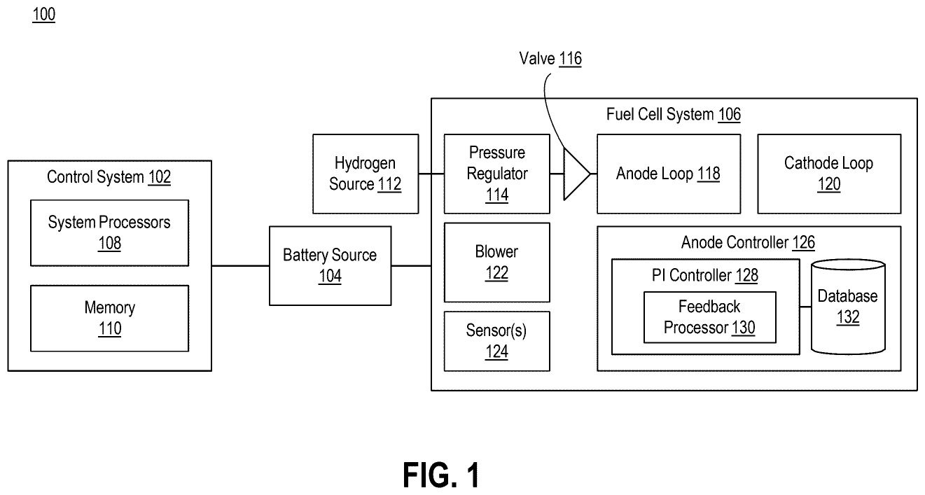

FIG. 1 is a block diagram of a system 100 for multi-input anode loop control for fuel cells. The system 100 may include at least one control system 102 communicably coupled to a fuel cell system 106 through a battery source 104. The control system 102 may be implemented in various environments or systems. For example, the control system 102 may be implemented in various vehicles or machinery for supplying power to the vehicle/machine(s), as a power generation system for homes or businesses (e.g., primary or back-up power), etc. In some embodiments, the control system 102 may be implemented in various heavy machinery components or vehicles to supply power thereto.

The control system 102 may include one or more system processors 108 (generally referred to as a “processor 108” or as “processors 108”) and memory 110. The processors 108 may be or include any device, component, element, or hardware designed or configured to perform the various steps recited herein. For example, the processors 108 may include any number of general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the control system 102 may include a single processor 108 designed or configured to perform each of the various steps recited herein.

In some embodiments, the control system 102 may include multiple processors 108 which are designed or configured perform (e.g., either separately or together) each of the various steps recited herein. As one example, the control system 102 may include a first processor 108 designed or configured to perform a first subset of the various steps, and a second processor 108 designed or configured to perform a second subset of the various steps (with the first subset being different from the second subset). As another example, the control system 102 may include first and second processors 108 which together perform the various steps in a distributed fashion. As such, unless explicitly indicated otherwise, such as by use of a term such as “a single processor”, the term “one or more processors” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors. The memory 110 may be or include any type or form of data storage device, including tangible, non-transient volatile memory and/or non-volatile memory.

The battery source 104 may be an external battery source separate from electrical components within the fuel cell system 106 or the anode controller 126. The battery source may provide, supply, or otherwise electrical energy to the various components of the fuel cell system 106. The control system 102 may trigger or cause the battery source 104 to supply power to the vehicle or the heavy machinery. In some embodiments, the battery source 104 may be implemented within the various heavy machinery to supply electrical power thereto.

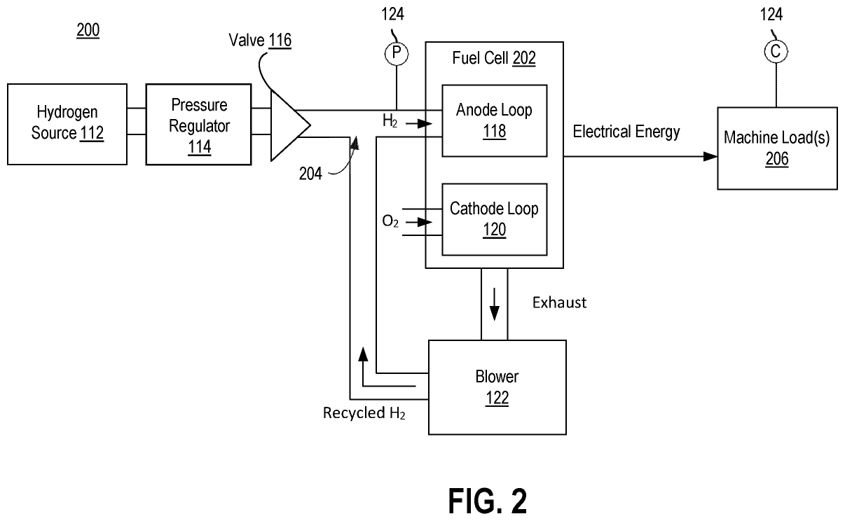

Referring now to FIG. 1 and FIG. 2, FIG. 2 is a block diagram 200 of the fuel cell system 106. The fuel cell system 106 may include a valve 116 fluidically coupled to a hydrogen source 112. The valve 116 may be configured to direct, blow, provide, or otherwise supply hydrogen (e.g., H₂) from a hydrogen source 112 to an anode loop 118. For example, the valve 116 may control the flow of hydrogen from the hydrogen source 112 to the fuel cell system 106. Upon entry to the fuel cell 106, the value 110 may direct or otherwise provide hydrogen to the hydrogen source and the anode loop 118. The fuel system 106 may transmit a signal to the control system 102 to adjust, control, or otherwise regulate the power output of the machine based on a demand for hydrogen. For example, the control system 102 may partially close the valve 116 to reduce the amount of supplied hydrogen from the hydrogen source 112 to the anode loop 118.

In some embodiments, the anode loop 118 may be fluidically coupled to the hydrogen source 112 (e.g., via the valve 116). In this regard, the term fluidically coupled encompasses both direct and indirect fluid connections. The hydrogen source 112 may be configured to provide or supply hydrogen to a pressure regulator 114. The pressure regulator 114 may be located downstream from the hydrogen source 112 and upstream from the valve 116. In some embodiments, the pressure regulator 114 may be configured to increase, decrease, or otherwise adjust the supplied hydrogen from the hydrogen source 112 for supply to a proton exchange membrane (PEM) (e.g., an anode loop 116 of a PEM fuel cell 202 corresponding to the fuel cell system 106). In some embodiments, the cathode loop 120 may have air (e.g., ambient air, oxygen) supplied thereto. Using hydrogen supplied to the anode loop 118 and oxygen from the cathode loop 120, the fuel cell 202 may produce electrical energy and heat for one or more fuel cells. For example, the fuel cell 202 may generate or produce electrical energy by splitting the hydrogen of the anode loop 118 protons and electrons, whereas the oxygen of the cathode loop 120 may combine with the protons and electrons to produce electricity and water, with heat generated as a byproduct.

The fuel cell system 106 may include a blower 122 to supply hydrogen to the anode loop 118. The blower 122 may be fluidically coupled to an exhaust, valves, pump, etc., to recirculate hydrogen into the anode loop 118. For example, the blower 122 can recirculate hydrogen from the exhaust into the anode loop 118. By using the blower 122, the fuel cell system 106 can recycle hydrogen, to reduce the amount of hydrogen lost from the exhaust. While the system described herein is depicted and described with a single blower 122 (e.g., a single HRB), it is noted that the systems and methods described herein may implement, include, or otherwise use multiple HRBs. Accordingly, the present disclosure is not limited to implementations including a single blower 122, and rather contemplates other implementations including multiple blowers 122 (e.g., in a stacked or multi-stack arrangement).

The anode controller 126 may monitor, control, or otherwise regulate the blower 122 by sending one or more signals to the blower 122. The signals may indicate an optimized recirculated hydrogen threshold for the amount of hydrogen supplied by the blower 122. The signal may cause the blower 122 to increase, decrease, or otherwise regulate the amount of hydrogen entering the anode loop 118 to maintain the optimized recirculated hydrogen threshold (e.g., by increasing, decreasing, or otherwise regulating a fan speed corresponding to the blower 122). The optimized recirculated hydrogen threshold may indicate an optimal performance of the fuel cell system 106. For example, the anode controller 126 may reduce the amount of hydrogen the blower 122 supplies to the anode loop 118 (e.g., by reducing a fan speed of the blower 122) to prevent the fuel cell system 106 from over-ingesting hydrogen (or over-saturating the anode loop 118 with hydrogen) and maintain performance according to (or near) he optimized recirculated hydrogen threshold. In another example, the control system 102 may increase the amount of hydrogen the blower 122 supplies to the anode loop 118 to prevent starvation (or undersaturation) of the fuel cell system 106 and maintain performance near the optimized recirculated hydrogen threshold.

The fuel cell system 106 may include sensors 120. The sensors 120 may include current sensors 120 and pressure sensors 120. As shown in FIG. 2, and in some embodiments, the pressor sensors 120 may be arranged upstream from the valve 116 and a juncture 204 which fluidically couples the blower 122 to an inlet of the anode loop 118. The pressure sensors 120 may sense, detect, or monitor an anode inlet pressure. The anode inlet pressure may be the pressure of hydrogen gas or hydrogen fluid entering the anode loop 118 of the fuel cell system 106. Maintaining an appropriate or optimal anode inlet pressure may impact reaction gas rates, gas diffusion, and fuel cell performance. For example, if the anode inlet pressure increases beyond a threshold anode inlet pressure within the fuel cell system 106, the fuel cell system 106 may exhaust more hydrogen than the blower 118 may recirculate, resulting in excess hydrogen. The pressor sensors 120 may transmit the anode inlet pressure to the anode controller 126. The anode controller 126 may use the anode inlet pressure to determine, identify, or provide an optimal anode inlet pressure at the anode loop 118. For example, the anode controller 126 may use the anode inlet pressure, a temperature of the fuel cell, and a volumetric flow of hydrogen from the blower 122 for the fuel cell system 106 to calculate an optimal anode inlet pressure. In response to the optimal anode inlet pressure, the anode controller 126 may close the valve 116 to reduce the amount of hydrogen supplied to the anode loop 118.

The anode controller 126 may include general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. The anode controller 126 may determine, calculate, or otherwise generate a target anode inlet pressure according to a current demand. For example, and as shown in FIG. 2, one or more current sensors 120 may be arranged or configured to transmit, send, or otherwise provide the current demand of the machine (e.g., machine loads 206) to the anode controller 126. The current demand may increase or decrease according to the load of the machine. For example, a bulldozer may carry one or more boulders in the blade. Due to the increase of weight of the bulldozer, the current demand may increase to power the bulldozer. In another example, a heavy machine may park at the end of a workday. Thus, the current demand may decrease as the heavy machine does not include a load. The target anode inlet pressure may indicate or identify the optimal anode inlet pressure described above.

The anode controller 126 may determine, generate, or otherwise calculate the target anode inlet pressure based on a space velocity (SV). The SV may describe a flow rate of reactants (e.g., hydrogen or oxygen) or products (e.g., water) through a reactor. The SV may measure how quickly the reactants or products move through the reaction. For example, a high SV corresponds to a faster flow of reactants through the reactor, which may result in shorter contact times between the reactants and the catalyst of the reaction. In another example, a lower SV allows for a longer contact time, potentially leading to more complete reactions.

The anode controller 126 may determine, generate, or otherwise calculate the target anode inlet pressure based on an inlet air mass flow (IAMF). The IAMF may correspond to the rate at which air (e.g., Oxygen) is supplied to the fuel cell system 106. The IAMF may influence the efficiency and performance of the fuel cell 202 by monitoring if sufficient oxygen is present for the reaction to occur. The anode controller 126 may use the current demand, a power of the machine, an average voltage of the machine, and a weighted value to determine the IAMF. In some embodiments, the anode controller 126 may determine the target anode inlet pressure as a function of a sensed temperature within the fuel cell system 106. The sensors 120 can include a temperature sensor 124 to detect, monitor, and identify changes in the temperature of the fuel cell system 106. The temperature sensor 124 may indicate that the temperature of the fuel cell system 106 is high to the anode controller 126. The anode controller 126 may reduce the target anode inlet pressure to protect the health of the fuel cell system 106.

The anode controller 126 may include a proportional and integral (PI) controller 128 and a database 132. The PI controller 128 may include a proportional term and an integral term. The proportional term may be proportional to an error or error signal (e.g., generated in real-time). The error signal may be representative of the difference between desired or target anode inlet pressure and the actual anode inlet pressure detected by the pressure sensor 124. The anode controller 126 may use the error signal to adjust parameters for the valve 116 and the blower 122 to reduce the error signal. An output may be proportional to the magnitude of the error. The proportional term may reduce the steady-state error. The steady-state error may be a difference between an operational point and an actual output when the fuel cell system 106 reaches a stable condition. The integral term may be proportional to an acclimation, summation, or otherwise a collection of errors during a plurality of previous time periods. The integral term may reduce or eliminate a residual steady-state error that remains after the proportional term. The integral term may indicate or identify information related to the fuel cell system 106 and long-term error correction. While described as a PI controller 128, in various embodiments, other forms of feedback controllers may be implemented by the anode controller 126, such as proportional controllers (P controllers), proportional-integral-derivative (PID) controllers, or any other feedback controller.

By using both the proportional term and the integral term, the anode controller 126 may execute, trigger, or cause the PI controller 128 to generate the anode inlet pressure as an error signal. For example, the anode controller 126 may receive or retrieve the anode inlet pressure from the sensors 120. The anode controller 126 may execute the PI controller 128 upon reception of the anode inlet pressure and represent the anode inlet pressure as an error signal. The PI controller 128 or the anode controller 126 can generate the error signal based on the anode inlet pressure and the error from the proportional term and the integral term. The PI controller 128 can include a feedback processor 130 to execute a feedback control loop. The feedback processor 130 may execute the feedback control loop, by using the anode inlet pressure.

The anode controller 126 may control the blower 122, by executing the feedback control loop. For example, by executing the feedback control loop, using the anode inlet pressure, the anode controller 126 may reduce the rate of recycled hydrogen supplied to the anode loop 118, by the blower 122. In another example, by executing the feedback control loop, using the anode inlet pressure, the anode controller 126 may increase the rate of recycled hydrogen supplied to the anode loop 118, by the blower 122. In yet another example, executing the feedback control loop, using the anode inlet pressure, the anode controller 126 may maintain the rate of recycled hydrogen supplied to the anode loop 118, by the blower 122.

To control the blower 122, the anode controller 126 may generate a blower control signal for the blower 122. The blower control signal can include instructions to increase, decrease, or adjust the amount of hydrogen recirculating to the anode loop 118, based on the target anode inlet pressure. For example, the blower control signal may cause the blower 122 to increase the amount of hydrogen recirculating to the anode loop 118, in response to the anode controller determining that the anode inlet pressure is less than the target anode inlet pressure. In another example, the blower control signals may cause the blower to decrease the amount of hydrogen recirculating to the anode loop 118, in response to the anode controller determining that the anode inlet pressure is more than the target anode inlet pressure. Using the error signal, the anode controller 126 may generate an error blower control signal for the blower 122 based on the target anode inlet pressure. The error blower control signal may include instructions similar to the blower control signal and cause the blower 110 to increase, decrease, or adjust the amount of hydrogen recirculating to the anode loop 118. The anode controller may generate the error blower control signal to reduce the error signal of the PI controller 128.

The anode controller 126 may control the valve 116 in a similar manner to the control system described above for controlling the blower 110, by executing the feedback control loop. For example, executing the feedback control loop, using the anode inlet pressure, the anode controller 126 may increase the opening of the valve 116 to supply more hydrogen to the anode loop 118. In another example, executing the feedback control loop, using the anode inlet pressure, the anode controller 126 may decrease the opening of the valve 116 to supply less hydrogen to the anode loop 118. In yet another example, executing the feedback control loop, using the anode inlet pressure, the anode controller 126 may maintain the opening of the valve 116 to supply constant hydrogen to the anode 114.

To control the valve 116, the anode controller 126 may generate a valve control signal for the valve 116. The valve control signal can include instructions to increase, decrease, or adjust the amount of hydrogen supplied to the anode loop 118, based on the target anode inlet pressure. For example, the valve control signal may cause the opening of the valve 116 to increase and supply more hydrogen to the anode loop 118, in response to the anode controller determining that the anode inlet pressure is less than the target anode inlet pressure. In another example, the valve control signal may cause the opening of the valve 116 to decrease and supply less hydrogen to the anode loop 118, in response to the anode controller determining that the anode inlet pressure is more than the target anode inlet pressure. Using the error signal, the anode controller 126 may generate an error valve control signal for the valve 116 based on the target anode inlet pressure. The error valve control signal may include instructions similar to the valve control signal and cause the valve 116 to increase, decrease, or adjust the hydrogen supplied to the anode loop 110. The anode controller may generate the error valve control signal to reduce the error signal of the PI controller 128.

### INDUSTRIAL APPLICABILITY

The disclosed embodiments may be applicable to any fuel cell-based system or solution. For example, the disclosed embodiments may be applicable to or applied to a vehicle, such as an automobile, heavy machinery, or any other type of vehicle, a power source for a home, office, or any other residential/industrial setting, or any other power delivery system which may be powered by a fuel cell. The disclosed embodiments may be applicable to fuel cell-based systems which use or include HT-PEM fuel cells, or fuel cells which struggle to optimize hydrogen within the fuel cell system 106. The disclosed anode controller 126 may be provided to optimize hydrogen within the fuel cell system 106, by simultaneously controlling the valve 116 and the blower 122 to maintain peak performance of the fuel cell system 106 based on feedback according to the error signal generated by the anode controller 126. For example, the anode controller may trigger the valve 116 to open or close (and/or increase or decrease the blower 122 output) based on various factors provided by the control system 102 and from equations to calculate the target anode inlet pressure.

In various embodiments, the systems and methods described herein may also be implemented in an ejector-based system, or an ejection and blower-based (e.g., ejector combined with a blower) system. In such a system, the control system 102 may control the blower speed to vary with the load, but may be shut off at higher loads. Such an implementation may provide various benefits, including less balance of plant (BoP) power at the low end (e.g., lower loads) than systems which include a single blower (e.g., a single blower which produces higher output).

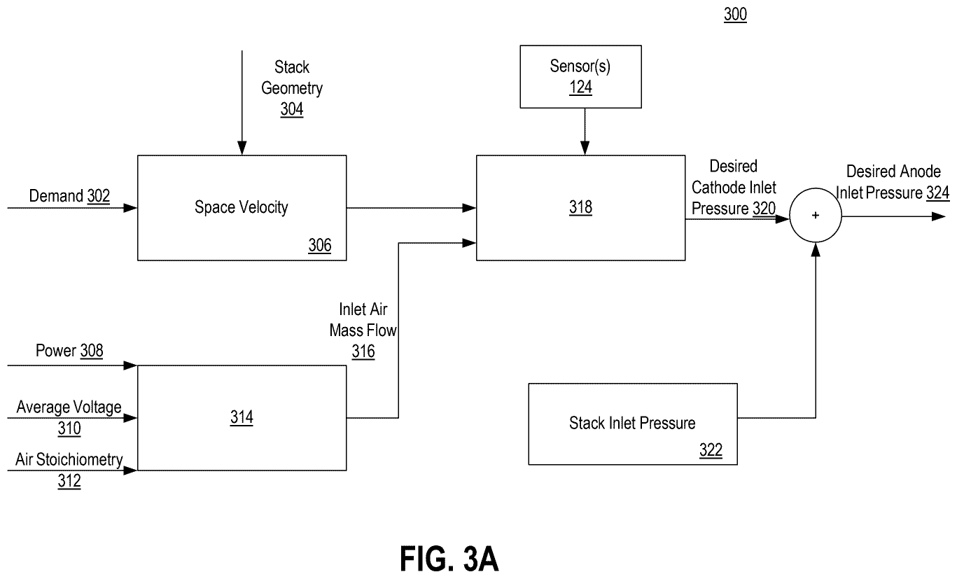

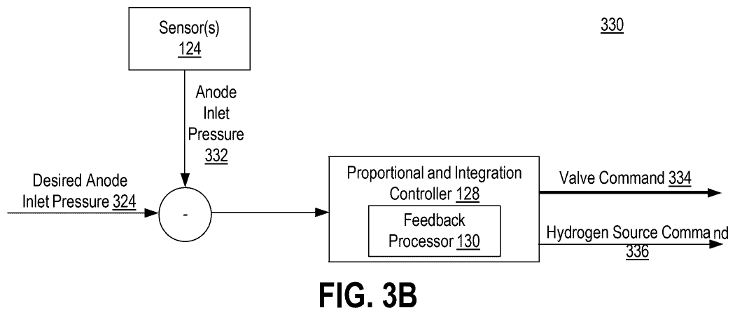

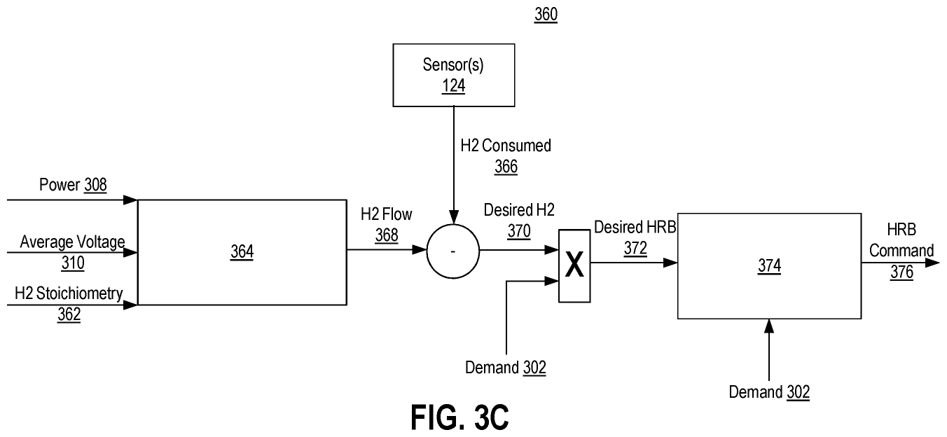

Referring now to FIGS. 3A-3C, are flowcharts 300, 330, and 360, respectively, of the multi-input anode loop. The flowcharts 300, 330, and 360 may be executed by the anode controller 126 of the fuel cell system 106. Referring to FIG. 3A, in the flowchart 300, the anode controller 126 may calculate, determine, or generate the SV 306, based on or according to the current demand 302 and stack geometry 304. In parallel, the anode controller 126 may calculate the IAMF 316 using/based on/according to the power demand 308 of the machine, the average voltage 310 of the battery source 104, and the air stoichiometry 312. For example, the anode controller 126 may determine the IAMF 316 at block 314, using the equation 1 below, where P_{c} is the power demand, V_{c} is the average voltage 310, and λ is the air stoichiometry:

$$3.57 * 1 {0}^{- 7} * λ * {P}_{c} * {V}_{c} \qquad ( 1 )$$

Responsive to determining the SV 306 and the IAMF 316, the anode controller 126 may determine, compute, or otherwise calculate the desired cathode inlet pressure 320. For example, the anode controller 126 may determine, compute, or otherwise calculate the desired cathode inlet pressure 320 (P) at block 318, using the equation 2 below (e.g., the ideal gas law):

$$P = \frac{m * R * T}{N * V} \qquad ( 2 )$$

The anode controller 126 may receive sensor data from the sensors 120 (e.g., the pressure sensor, current sensor, and/or temperature sensor) to calculate the desired cathode inlet pressure 320. The anode controller 126 may add a stack inlet pressure 322 and the desired cathode inlet pressure 320 to generate a desired anode inlet pressure 324 (e.g., the target anode inlet pressure).

Referring now to FIG. 3B, the flowchart 330 may be a continuation of the flowchart 300. The anode controller 126 may compute a differential of the target anode inlet pressure 324 and the anode inlet pressure 322 from the pressure sensor 124. The anode controller 126 may provide the difference to the PI controller 120. The feedback processor 130 of the PI controller 128 can execute the feedback loop to generate a valve command 334. The valve command 334 may include a valve area command (e.g., to adjust the opening area of the valve 116), a valve position command (e.g., adjust the position of the valve 116), and/or a valve current command (e.g., drive the valve 116 according to the current). The anode controller 126 may provide the valve area command 334 to the valve 116.

In some embodiments, the feedback processor 130 of the PI controller 128 can execute the feedback loop to generate a hydrogen source command 336. The hydrogen source command 336 may control the concentration or the flow of hydrogen fed into the fuel cell system 104. In some embodiments, the feedback processor 130 may separately control the valve 116 and they hydrogen source 112. For example, the feedback processor 130 may transmit the valve command 334 and the hydrogen source command 336 to the valve 116 and the hydrogen source 112, respectively. The valve command 334 may increase the valve area, whereas the hydrogen source command 336 may decrease the flow of hydrogen in the hydrogen source 112. Thus, providing the anode loop 118 with a short burst of hydrogen. In another example, the feedback processor 130 may transmit the valve command 334 and the hydrogen source command 336 to the valve 116 and the hydrogen source 112, respectively. The valve command 334 may decrease the valve area, whereas the hydrogen source command 336 may increase the flow of hydrogen in the hydrogen source 112. Thus, providing the anode loop 118 with a high concentration of hydrogen yet using minimal levels of the hydrogen.

Referring now to FIG. 3C, the flowchart 360 may occur in parallel to the flowchart 300 and the flowchart 330. The anode controller 126 may use the power demand 308, average voltage 310 of the battery source 104, and a hydrogen stoichiometry 362 to generate, compute, or otherwise determine a hydrogen flow 366. For example, the anode controller 126 may compute the hydrogen flow 368 at block 364 using equation 3 below:

$$1.05 * 1 {0}^{- 8} * {P}_{e} * {V}_{c} \qquad ( 3 )$$

The anode controller 126 may subtract the hydrogen flow 366 and the hydrogen consumed 368 to generate a desired or target hydrogen concentration 370. The anode controller 126 can compute a desired hydrogen recirculation blower value (HRB) 372, as a function of the desired hydrogen 370 and the current demand 302 (e.g., by multiplying the desired hydrogen 370 and the current demand 302). The anode controller 126 may compute or otherwise determine an HRB command 376 as a function of the desired HRB 372 and the current demand 302. For example, the anode controller 126 may compute the HRB command 376 at block 374, using equation 4 below:

$$m = \frac{P * V * N}{R * T} \qquad ( 3 )$$

The anode controller 126 may transmit the HRB command to the blower 122.

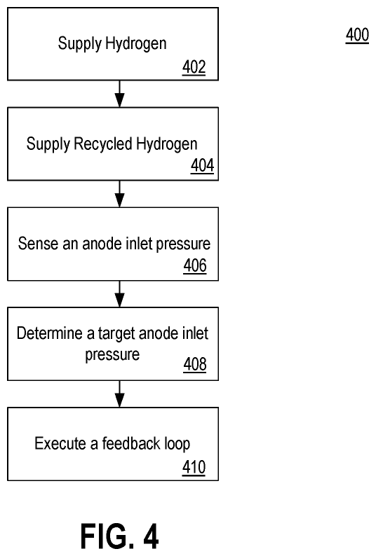

Referring now to FIG. 4, depicted is a flowchart showing an example method 400 for the multi-input anode loop control for fuel cells. The method 400 may be performed by, implemented on, or otherwise executed by the components, elements, or hardware described above with reference to FIG. 1 through FIGS. 3A-3C. For example, the method 400 may be executed by the components of FIG. 1. As a brief overview, at step 402, the valve 116 may supply hydrogen from the hydrogen source 112 to the anode loop 118. At step 404, the blower 122 may supply recycled hydrogen to the anode loop 118. At step 406, the sensors may sense the anode inlet pressure 322. At step 408, the anode controller 126 may determine the target anode inlet pressure 324. At step 410, the anode controller 126 may execute the feedback loop.

At step 402, the valve 116 may supply hydrogen from the hydrogen source 112 to the anode loop 118. In some embodiments, the pressure regulator 114 may supply hydrogen from the hydrogen source 112. Once the pressure regulator 114 receives the hydrogen from the hydrogen source 112, the valve 116 may supply or otherwise provide the hydrogen to the anode loop 118. In some embodiments, the valve 116 may provide the hydrogen directly to the anode loop 118. The anode controller 126 may regulate an opening of the valve 116 to provide more or less hydrogen to the anode loop 118. In this regard, the fuel system 106 may receive a first input of hydrogen into the anode loop 118.

At step 404, the blower 122 may supply recycled hydrogen to the anode loop 118. In some embodiments, the blower 122 may supply hydrogen from an exhaust of fuel cell 202 to the anode loop 118. For example, the blower 122 may transmit hydrogen from the exhaust of the fuel cell 202 back into the anode loop 118. In some embodiments, the blower 122 may supply hydrogen from a pump in the heavy machine to the anode loop 118. The anode controller 126 may regulate a rate of recirculation of the blower 122 to provide more or less hydrogen to the anode loop 118. In this regard, the fuel system 106 may receive a second input of hydrogen into the anode loop 118.

At step 406, the sensors 120 may sense the anode inlet pressure 322. In some embodiments, the sensors 120 may detect the current anode inlet pressure from the fuel cell system 106 by using the pressure sensor 124. The pressure sensor 124 may transmit a signal to the anode controller 126 and the control system 102 on demand, at various intervals, or periodically, when the anode inlet pressure rises past a threshold or falls below a threshold, etc. For example, the pressure sensor 124 may monitor the anode inlet pressure 332 and constantly transmit the signal of the anode inlet pressure 332 to the anode controller 126. In this regard, the sensors 120 may continuously transmit the anode inlet pressure to the anode controller 126. The pressure sensor is arranged upstream from the valve, and a juncture 204 which fluidically couples the blower to an inlet of the anode loop

At step 408, the anode controller 126 may determine the target anode inlet pressure 324, according to the current demand 302. The current sensor 124 may provide the current demand 302 to the anode controller 126. The current demand 302 may correspond to an increase in load at the heavy machinery or vehicle. In this regard, the anode controller 126 may determine the target anode inlet pressure 324 as a function of the load (e.g., load demand from a given module of the heavy machinery or vehicle). The anode controller 126 may determine the target anode inlet pressure 324, and track the anode inlet pressure 322, based on the load demand. In some embodiments, the anode controller 126 may determine/track the individual pressures for systems with one or more fuel cell modules (e.g., fuel cell modules stacked in parallel), based on the load demand for each respective fuel cell module. As such, while the systems and methods described herein are applicable to single fuel cell modules, the systems and methods described herein may also be applied to multi-fuel cell module systems (e.g., fuel cell modules stacked in parallel and supplying different portions of the load amongst different fuel cell modules).

The stack geometry 304 and the current demand 302 may define the space velocity. The control system 102 may transmit the power demand 308, the average voltage 310 of the battery source 104, and air stoichiometry 312, to the anode controller 126 to calculate the inlet air mass flow 316. The anode controller 126 may use the space velocity 306 and the inlet air mass flow 316 to calculate the target cathode inlet pressure 320. By adding the target cathode inlet pressure and the stack inlet pressure 322, the anode controller 126 may determine the target anode inlet pressure 324. The stack inlet pressure 322 may correspond to a sensed temperature from temperature sensor 122.

At step 410, the PI controller 128 may execute the feedback loop, using the anode inlet pressure 332, to control the blower 122 and the valve 116, to supply hydrogen to the anode loop 118. In some embodiments, the anode controller may execute the feedback control loop, by executing PI controller 126 which receives the anode inlet pressure 322 of the pressure sensor 122 and generates an error signal by subtracting the target anode inlet pressure 324 and the anode inlet pressure 332. The PI controller 126 may generate a hydrogen source 112 and/or valve 116 command 334 to control the valve 110 and/or the hydrogen source 112. The anode controller 126 may subtract the amount of hydrogen consumed 366 and amount of hydrogen flowing 368 to generate the target amount of hydrogen 372 supplied to the anode loop 118. The current demand 302 and the target amount of hydrogen 372 may define the target HRB 376. For example, the anode controller may generate the HRB command 376 as described above with reference to FIG. 3C.

In some embodiments, the anode controller 126 may execute a feedforward loop for controlling hydrogen supply. For example, and in some instances, controlling the valve 116 (or other valves, such as a purge valve) may cause changes in the anode inlet pressure 322 and/or hydrogen supply, even when the system is at steady state. The anode controller 126 may execute the feedforward loop to offset the desired anode inlet pressure, to supply additional hydrogen to the anode when the valve 116 is cycled open. The feedforward loop may include, as an input, the load and supply pressure. When the anode controller 126 determines that the valve 116 is opened to purge hydrogen, the anode controller 126 may execute the feedforward loop to increase (or modify/change) the supply of hydrogen to the anode loop, to replenish the supply of hydrogen thereto.

In some embodiments, the anode controller 126 may generate the HRB command 376 and the hydrogen source and/or valve command 110 from, based on, or according to the error signal. The hydrogen source and/or valve command 110 and the HRB command 376 may control the valve 116 and the blower 122 as described above. In this regard, the inefficient use of the components results in a higher carbon footprint by not reutilizing excess hydrogen may be avoided.

In various embodiments of the present solution, the control system 102 may transmit the current demand 302 to the anode controller 126, while the cathode loop 120 transmits air stoichiometry to the anode controller 126. By using various equations (e.g., equation 314, equation 318), the anode controller 126 may generate hydrogen source and valve 116 command from the target anode inlet pressure 324 and an error signal for the anode inlet pressure. Thus, the anode controller 126 may continuously adjust the valve 116 and the hydrogen source 112 to reduce hydrogen waste and protect the health of the fuel cells system 106 while maintaining peak performance of the anode loop 118.

In various embodiments of the present solution, the control system 102 may transmit the current demand 302 to the anode controller 126, while the anode loop 118 transmits hydrogen stoichiometry to the anode controller 126. By using various equations (e.g., equation 364, equation 374), the anode controller 126 may generate the HRB command 376 for the blower 122 by leveraging the calculated (target) HRB 372 and the current demand 302. Thus, the anode controller 126 may continuously adjust rate of recirculation of the blower 122 to prevent starvation hydrogen in the fuel cell system 106 and prevent an over-abundance of hydrogen in the fuel cell system 106, while maintaining peak performance of the anode loop 118.

What is claimed is:

1. A fuel cell system, comprising:
a valve fluidically coupled to a hydrogen source and configured to supply hydrogen to an anode loop;
a blower arranged to supply recycled hydrogen to the anode loop;
a pressure sensor configured to sense an anode inlet pressure; and
an anode controller, configured to:
determine a target anode inlet pressure, according to a current demand; and
execute a feedback control loop, using the anode inlet pressure, to control the blower and the valve, to supply hydrogen to the anode loop.

2. The fuel cell system of claim 1, wherein the anode controller executes the feedback control loop, by executing a proportional and integral (PI) controller which receives the anode inlet pressure of the pressure sensor as an error signal.

3. The fuel cell system of claim 1, wherein the anode controller is further configured to:
generate i) a blower control signal for the blower and ii) a valve control signal for the valve, to supply the hydrogen to the anode loop, according to the target anode inlet pressure.

4. The fuel cell system of claim 3, wherein the anode controller is further configured to:
determine, according to the anode inlet pressure, an error signal; and
generate, according to the error signal, at least one of a second blower control signal or a second valve control signal, to supply the hydrogen to the anode loop according to the target anode inlet pressure.

5. The fuel cell system of claim 3, wherein the anode controller is configured to generate the at least one of the second blower control signal or the second valve control signal, to reduce the error signal.

6. The fuel cell system of claim 1, wherein the pressure sensor is arranged upstream from the valve, and a juncture which fluidically couples the blower to an inlet of the anode loop.

7. The fuel cell system of claim 1, wherein the anode controller is configured to determine the target anode inlet pressure, according to a space velocity and an inlet air mass flow, the inlet air mass flow determined according to the current demand, a power demand, a weighted value, and an average voltage.

8. The fuel cell system of claim 7, wherein the anode controller determines the target anode inlet pressure, as a function of a sensed temperature within the fuel cell system.

9. The fuel cell system of claim 1, further comprising a pressure regulator fluidically coupled upstream from the valve, wherein the value supplied hydrogen to the anode loop via the pressure regulator.

10. A method comprising:
receiving, by an anode controller, an anode inlet pressure of an anode loop of a fuel cell;
determining, by an anode controller, a target anode inlet pressure, according to a current demand; and
executing, by the anode controller, using the anode inlet pressure, a feedback loop to control 1) a valve a valve fluidically coupled to a hydrogen source and configured to supply hydrogen to the anode loop, and 2) a blower arranged to supply recycled hydrogen to the anode loop, to supply hydrogen to the anode loop.

11. The method of claim 10, wherein executing the feedback control loop further comprising executing, by the anode controller, a proportional and integral (PI) controller which receives the anode inlet pressure of the pressure sensor as an error signal.

12. The method of claim 10, further comprising:
generating, by the anode controller, a blower control signal for the blower; and
generating, by the anode controller, a valve control signal for the valve, to supply the hydrogen to the anode loop, according to the target anode inlet pressure.

13. The method of claim 12, further comprising:
determining, by the anode controller, according to the anode inlet pressure, an error signal; and
generating, by the anode controller, according to the error signal, at least one of a second blower control signal or a second valve control signal, to supply the hydrogen to the anode loop according to the target anode inlet pressure.

14. The method of claim 12, further comprising generating, by the anode controller, the at least one of the second blower control signal or the second valve control signal, to reduce the error signal.

15. The method of claim 10, wherein the pressure sensor is arranged upstream from the valve, and a juncture which fluidically couples the blower to an inlet of the anode loop.

16. The method of claim 10, further comprising determining, by the anode controller, the target anode inlet pressure, according to a space velocity and an inlet air mass flow, the inlet air mass flow determined according to the current demand, a power, and an average voltage.

17. The method of claim 16, wherein the inlet air mass flow is further determined according to a weighted value.

18. The method of claim 16, wherein the anode controller determines the target anode inlet pressure, as a function of a sensed temperature within the method.

19. An anode controller, comprising:
one or more processors configured to:
determine a target anode inlet pressure for an anode loop of a fuel cell system, according to a current demand;
receive, from an anode inlet pressure sensor, an anode inlet pressure; and
execute a feedback control loop, using the anode inlet pressure, to control a blower arranged to supply recycled hydrogen to the anode loop and a valve fluidically coupled to a hydrogen source and configured to supply hydrogen to the anode loop, to supply hydrogen to the anode loop.

20. The anode controller of claim 19, wherein the anode controller executes the feedback control loop, by executing a proportional and integral (PI) controller which receives the anode inlet pressure of the pressure sensor as an error signal.
